(19) United States
(12) Patent Application Publication
(10) Pub. No.: US 2023/0108018 A1
(43) Pub. Date: Apr. 6, 2023

(54) Hydrolytically Stable Phosphite Composition, Polymer Composition Comprising Said Hydrolytically Stable Phosphite Composition

(71) Applicant: SI GROUP SWITZERLAND GMBH, Pratteln (CH)

(72) Inventors: Jonathan Hill, Manchester (GB); Jonathan Byrne, Manchester (GB)

(21) Appl. No.: 17/910,032

(22) PCT Filed: Mar. 11, 2021
(86) PCT No.: PCT/EP2021/056155

§ 371 Date: Sep. 8, 2022

(30) Foreign Application Priority Data
Mar. 11, 2020 (GB) 2003550.7

(51) Int. Cl. C08K 5/526; C08K 5/3435; C08L 23/06

(52) U.S. Cl. CPC C08K 5/526; C08K 5/3435; C08L 23/06; C08K 2201/012; C08K 2201/014

(57) ABSTRACT

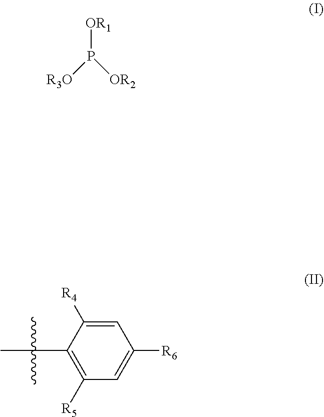

The invention provides a hydrolytically stabilised phosphite composition, comprising: a. a phosphite antioxidant which is a liquid at ambient conditions and comprises a blend of at least two different phosphites of Formula I: wherein R₁, R₂ and R₃ are independently selected alkylated aryl groups of Formula II: wherein R₄, R₅ and R₆ are independently selected from the group consisting of hydrogen and C₁ to C₆ alkyl, provided that at least one of R₄, R₅ and R₆ in each phosphite is selected from the group consisting of tert-butyl and/or tert-pentyl; and b. a nitrogen-containing compound comprising a nitrogen atom, wherein the nitrogen atom: i. has a pKaH value of from about 7 to about 11; and ii. is sp³ hybridised, and wherein the nitrogen-containing compound is absent any labile protons.

The present invention concerns compositions involving a hydrolytically stabilised phosphite antioxidant. The present invention also concerns polymers stabilised by the composition, and useful articles made from such polymers.

Phosphites, particularly organic phosphites, are used as secondary antioxidants for stabilising polymers such as polyolefins and elastomers. Phosphite antioxidants are able to reduce the formation of free radicals by decomposing unstable hydroperoxides that are formed during the autooxidation of polymers.

However, a common problem with such phosphite antioxidants is their tendency to hydrolyse via an autocatalytic reaction when exposed to water or moisture, particularly during storage or handling.

To address this problem, it is known to use hydrostabilisers in combination with phosphite antioxidants. These impart improved hydrolytic stability to phosphite antioxidants, particularly during storage or handling but also when used in-polymer.

A class of compounds known to be effective hydrostabilisers are alkanolamines, for example triisopropanolamine (TIPA) which has been found to be very effective in relatively small amounts.

US 2004/0127610 describes a polyolefin composition comprising: at least one polyolefin; bis(2,4-dicumylphenyl)pentaerythritol diphosphite; triisopropanolamine; a hydrotalcite component; and at least one phenol component.

WO 2011/014529 describes a composition comprising: a phosphite; and an amine having the structure:

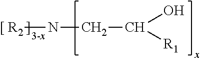

wherein x is 1, 2 or 3; R₁ is selected from the group consisting of hydrogen, and straight or branched C₁-C₆ alkyl, and R₂ is selected from the group consisting of straight or branched C₁-C₃₀ alkyl.

However, whilst alkanolamines such as TIPA provide good hydrolytic stability to phosphite antioxidants, there are certain problems associated with their use. It has been found that the free —OH group(s) in alkanolamines slowly react with the phosphite antioxidant over time in a transesterification reaction which produces unwanted products, for example alkylphenols such as nonylphenol, 2,4-di-tert-butylphenol (24DTBP) and p-tert-amylphenol (PTAP).

As an alternative to alkanolamines, simple trialkylamines (R3N) have been contemplated in the prior art. Simple trialkylamines have been found to provide some hydrolytic stability to phosphite antioxidants. However, due to their high basicity they have been found to catalyse phosphite hydrolysis as explained in ‘The Handbook of Polymer Degradation’ (2^{nd} Edition), page 96.

Sterically hindered amines have also been considered as hydrostabilisers for phosphite antioxidants.

U.S. Pat. No. 5,840,954 describes a composition comprising: 80 to 99.9% by weight of a solid organic phosphite or phosphonite or a mixture thereof; 0.1 to 20% by weight relative to the phosphite or phosphonite or mixture thereof, of a sterically hindered amine containing at least one group of the formula:

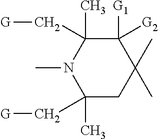

wherein G is hydrogen or methyl and G₁ and G₂ are hydrogen, methyl or together are ═O.

US 2019/0375915 describes compositions comprised of diene-based elastomers containing an antioxidant comprised of a combination of tris(nonylphenyl) phosphite (TNPP) and tetramethylethylene diamine (TMEDA). However, there may be regulatory concerns surrounding the use of TNPP due to the presence of nonylphenol compounds (branched and linear) in the phosphite.

There remains a need for a hydrolytically stabilised liquid phosphite composition which overcomes the above-identified problems associated with the prior art compositions, and which satisfies the requirements of the composition with regard to shelf life, sensitivity to hydrolysis, colour stability and turbidity. Turbidity can be a particular problem in liquid phosphite compositions, and may be due to the generation of insoluble hydrolysis products including salts.

According to an aspect of the present invention there is provided a hydrolytically stabilised phosphite composition, comprising:
a. a phosphite antioxidant which is a liquid at ambient conditions and comprises a blend of at least two different phosphites of Formula I:

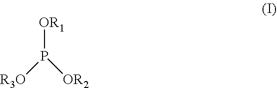

wherein R₁, R₂ and R₃ are independently selected alkylated aryl groups of Formula II:

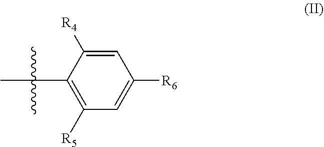

wherein R₄, R₅ and R₆ are independently selected from the group consisting of hydrogen and C₁ to C₆ alkyl, provided that at least one of R₄, R₅ and R₆ in each phosphite is selected from the group consisting of tert-butyl and/or tert-pentyl; and
b. a nitrogen-containing compound comprising a nitrogen atom, wherein the nitrogen atom:
   i. has a pKaH value of from about 7 to about 11; and
   ii. is sp³ hybridised,
and wherein the nitrogen-containing compound is absent any labile protons.

In one aspect of the invention the nitrogen-containing compound in the hydrolytically stabilised phosphite composition may have a pKaH value of from about 7 to about 10.8. In another aspect of the invention the nitrogen-containing compound in the hydrolytically stabilised phosphite composition may have a pKaH value of from about 7 to about 10.5. In another aspect of the invention the nitrogen-containing compound in the hydrolytically stabilised phosphite composition may have a pKaH value of from about 7 to about 10.2.

It has surprisingly been found that nitrogen-containing compounds according to the present invention provide good hydrolytic stability to the liquid phosphite antioxidants identified. The nitrogen-containing compound may be combined with the phosphite antioxidant to reduce hydrolysis during handling, during storage prior to use, and when the phosphite composition is added to a polymer to form polymer pellets, for example.

TIPA is a known industry standard hydrostabiliser which provides good hydrolytic stability to phosphite antioxidants. The present invention is intended to provide a satisfactory alternative to TIPA in terms of hydrolytic stabilisation function, without suffering unduly from the drawbacks of TIPA discussed above in creating unwanted transesterification products in the stabilised phosphite composition over time. The hydrolytic stability of the phosphite antioxidant in the composition according to the present invention relative to the hydrolytic stability of the same phosphite antioxidant stabilised with an equivalent amount of TIPA is at least about 0.4 relative to an equivalently TIPA-stabilised phosphite antioxidant.

Preferably, the hydrolytic stability of the phosphite antioxidant in the composition according to the present invention relative to the hydrolytic stability of the same phosphite antioxidant stabilised with an equivalent amount of TIPA is at least about 0.5, at least about 0.6, at least about 0.7, or at least about 0.8 relative to an equivalently TIPA-stabilised phosphite antioxidant.

As well as providing good hydrolytic stability, the composition of the invention is also effective to prevent, or at least substantially ameliorate or reduce, the appearance of turbidity in the stabilised phosphite composition over time. This is particularly advantageous in the liquid compositions of the invention, the appearance of turbidity in which can affect, or affect perceptions of, shelf life, performance and general efficacy. The hydrolytically stabilised phosphite compositions of the invention are typically supplied to polymer manufacturers in bulk for addition into polymer manufacturing processes. Shelf lives of the compositions as supplied are typically quoted as several months or even a year. In practice, the appearance of turbidity in a stabilised product will be detectable by the naked eye, and if no readily visible turbidity is apparent one month after manufacture of the stabilised composition, it may safely be assumed in most cases that the composition will remain acceptably free from turbidity for the duration of its advertised shelf life.

Accordingly, the hydrolytically stabilised phosphite composition of the invention may remain free from turbidity readily visible to the naked eye one month after production. The hydrolytically stabilised phosphite composition of the invention may have a turbidity of ≤10 NTU, for example ≤5 NTU, one month after production, turbidity being measurable by an ORION™ AQ3010 (available from ThermoFisher Scientific) turbidity meter.

Not only do the nitrogen-containing compounds according to the present invention provide good hydrolytic stability to the liquid phosphite antioxidants identified, but they also have the advantage of not reacting (or reacting only to a very limited extent) with the phosphite antioxidant in a transesterification reaction. This is beneficial as it means there is little or no production of unwanted transesterification products such as PTAP.

Accordingly, the present invention also provides a hydrolytically stabilised liquid phosphite composition comprising a transesterifiable phosphite antioxidant as identified, the composition being absent any hydrostabiliser capable of reacting with the phosphite antioxidant in a transesterification reaction.

Also provided in accordance with the invention is a hydrolytically stabilised liquid phosphite composition comprising a transesterifiable phosphite antioxidant as identified and a hydrostabiliser, the composition being absent any transesterified phosphite antioxidant.

In the following description PTAP is given as an example of an unwanted phosphite transesterification product. However, it will be apparent that the invention is equally applicable in circumstances in which the phosphite transesterification product is a different compound such as other substituted alkylphenols.

The amount of PTAP in the hydrolytically stabilised phosphite composition with 0.6 mole % of the nitrogen-containing compound after 48 days under nitrogen at ambient temperature may be no more than about 3 times higher than the initial amount of PTAP measured as the integral of the signal from the 2,6 hydrogens of PTAP in the ¹H NMR spectrum (doublet at 6.73 ppm) relative to the integral of signals from aromatic hydrogens resonating between 6.76 ppm and 7.7 ppm, with the sum of these 2 integrals set to 100 units and the chemical shift axis being calibrated to the internal standard TMS at 0.0 ppm, with the sample analysed at 298 K as 100 μL dissolved in 700 μL deuterochloroform and the resonance frequency of ¹H being 400 MHz.

Preferably, the amount of PTAP in the hydrolytically stabilised phosphite composition with 0.6 mole % of the nitrogen-containing compound after 48 days under nitrogen at ambient temperature is no more than about 2.5 times higher than the initial amount of PTAP, no more than about 2 times higher than the initial amount of PTAP, or no more than about 1.5 times higher than the initial amount of PTAP measured as the integral of the signal from the 2,6 hydrogens of PTAP in the ¹H NMR spectrum (doublet at 6.73 ppm) relative to the integral of signals from aromatic hydrogens resonating between 6.76 ppm and 7.7 ppm, with the sum of these 2 integrals set to 100 units and the chemical shift axis being calibrated to the internal standard TMS at 0.0 ppm, with the sample analysed at 298 K as 100 μL dissolved in 700 μL deuterochloroform and the resonance frequency of ¹H being 400 MHz.

The inventors of the present invention have surprisingly found that an important factor relating to the effectiveness of the nitrogen-containing compound as a hydrostabiliser is the pKaH value of the nitrogen atom in the compound. The pKaH value is the pKa value of the conjugate acid of the nitrogen atom.

More specifically, it has been found that a pKaH value in the range of from about 7 to about 11 is very effective. Without wishing to be bound by any such theory, it is believed that the pKaH value should not be higher than 11 as a higher basicity would promote base-catalysed hydrolysis of the phosphite antioxidant. The pKaH value should not be below 7 as this would be ineffective at neutralising acids. It has been found that no hydrostabilisation occurs when the pKaH value is 6 or lower, or when the pKaH value is 12 or higher. In some aspects of the invention the upper limit for the pKaH value may be below 11—for example 10.8, 10.5 or 10.2.

The following table exemplifies several nitrogen-containing compounds according to the present invention and the associated pKaH values of the nitrogen atom.

| Component | CAS No. | Chemical Description | pKaH |
|---|---|---|---|
| DIPEA | 7087-68-5 | diisopropyl ethylamine | 10.8 |
| LOWILITE ™ 76 | 41556-26-7 | Bis(1,2,2,6,6-pentamethyl-4- | 10 |
| | | piperidyl) sebacate | |
| LOWILITE ™ 77 | 52829-07-9 | Bis(2,2,6,6-tetramethyl-4- | 10 |
| | | piperidyl) sebacate | |
| LOWILITE ™ 92 | 41556-26-7 | Bis(1,2,2,6,6-pentamethyl-4- | 10 |
| | 82919-37-7 | piperidyl) sebacate and | |
| | | methyl(1,2,2,6,6-pentamethyl-4- | |
| | | piperidinyl) sebacate | |
| DABCO | 280-57-9 | 1,4-diazabicyclo[2.2.2]octane | 8.82 |
| TAA | 826-36-8 | Triacetonamine | 8.5 |
| NMM | 109-02-4 | N-methylmorpholine | 7.38 |

In some instances, the nitrogen-containing compound may comprise a nitrogen atom having a pKaH value of from about 9 to about 11.

The nitrogen-containing compound may comprise one or more electron-withdrawing groups. The one or more electron-withdrawing groups may contribute to the pKaH value of the nitrogen atom. The one or more electron-withdrawing groups may be located in close proximity to the nitrogen atom, for example the one or more electron-withdrawing groups may be located 2, 3 or 4 covalent bonds away from the nitrogen atom. The one or more electron-withdrawing groups may be selected from halogens (X) for example fluorine, chlorine and/or iodine atoms; oxygen-containing groups, for example ketone, ester and/or ether groups; and/or nitrogen-containing groups, for example nitro groups.

The nitrogen atom in the nitrogen-containing compound is sp³ hybridised. The lone pair of electrons on the nitrogen atom in an sp³ orbital is available to act as a Lewis base.

The nitrogen-containing compound is absent any labile protons. Labile protons are also known in the art as exchangeable hydrogen atoms. In this context, for a proton to be considered “labile” it must be covalently bonded to a heteroatom having at least one available lone pair of electrons and it must not be sterically blocked by neighbouring chemical groups. Examples of such heteroatoms may include N, O or S.

Due to the absence of any labile protons, the nitrogen-containing compounds according to the present invention do not react (or react only to a very limited extent) with the phosphite antioxidant in a transesterification reaction. This is advantageous as it means there is little or no production of unwanted transesterification products such as PTAP.

Labile protons include those in the following groups: —OH, —NH, —SH and —XH (where X is a halogen).

However, the nitrogen-containing compound may include one or more of the groups identified above if the proton within the group is not able to readily dissociate due to steric hindrance around the group i.e. it is not labile. It may be that the steric hindrance is provided by one or more tertiary alkyl groups in the α-position to the group.

In this context, the nitrogen-containing compound is considered not to contain protons which are “able to readily dissociate” if under typical handling conditions for the hydrolytically stabilised phosphite composition there is minimal PTAP generated over time, for example the amounts of PTAP defined above. Typical handling conditions may be temperatures of up to about 80° C., for example from about 60° C. to about 80° C.

As a specific example, the proton in the —NH group of triacetonamine (TAA) is not labile due to the steric hindrance provided by the tertiary alkyl groups in the α-position to the —NH group. Similarly, the proton in the —NH groups of LOWILITE™ 77 is not labile due to the steric hindrance provided by tertiary alkyl groups in the a-position to the —NH groups.

The nitrogen-containing compound may comprise a single nitrogen atom as defined or it may comprise multiple nitrogen atoms as defined.

The nitrogen-containing compound according to the invention may comprise one or more 2,2,6,6-tetramethyl-piperidine derivatives. Conventionally, such compounds are referred to as hindered amine light stabilizers (HALS) and have been used to stabilise polymers against free radical induced degradation. However, such compounds have not previously been used as a hydrostabiliser in combination with a liquid phosphite antioxidant to form a hydrolytically stabilised phosphite composition.

The 2,2,6,6-tetramethyl-piperidine derivative may comprise one or more groups having the following structure:

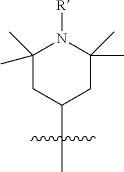

wherein R′ is hydrogen, CH₃, or CH₂R″ with R″ comprising —CH₂O(CO)CH₂CH₂CO₂— as a polymeric linker.

Specific, non-limiting examples of nitrogen-containing compounds according to the invention include bis(1,2,2,6,6-pentamethyl-4-piperidyl) sebacate (LOWILITE™ 76—CAS 41556-26-7); bis(2,2,6,6-tetramethyl-4-piperidyl) sebacate (LOWILITE™ 77—CAS 52829-07-9); mixtures of bis(1,2,2,6,6-pentamethyl-4-piperidyl) sebacate and methyl (1,2,2,6,6-pentamethyl-4-piperidinyl) sebacate (LOWILITE™ 92—CAS 41556-26-7 and CAS 82919-37-7); poly[[6-[(1,1,3,3-tetra methylbutyl)amino]-1,3,5-triazine-2,4-diyl][(2,2,6,6-tetra methyl-4-piperidyl)imino]hexamethylene[(2,2,6,6-tetramethyl-4-piperidyl)imino]] (LOWILITE™ 94—CAS 71878-19-8); 1,3,5-triazine-2,4,6-triamine, N2, N2′-1,2-ethanediylbis[N2-[3-[[4,6-bis[butyl(1,2,2,6,6-pentamethyl-4-piperidinyl)amino]-1,3,5-triazin-2-yl]amino]propyl]-N4,N6-dibutyl-N4,N6-bis(1,2,2,6,6-pentamethyl-4-piperidinyl)-(LOWILITE™ 19—CAS 106990-43-6); butanedioic acid, dimethyl ester, polymer with 4-hydroxy-2,2,6,6-tetramethyl-1-piperidine-ethanol (LOWILITE™ 62—CAS 65447-77-0); 1,6-hexanediamine, N,N′-bis(2,2,6,6-tetramethyl-4-piperidinyl)-, polymer with 2,4,6-trichloro-1,3,5-triazine, reaction products with N-butyl-1-butanamine and N-butyl-2,2,6,6-tetramethyl-4-piperidinamine (CAS 192268-64-7); poly[(6-morpholino-1,3,5-triazine-2,4-diyl)((2,2,6,6-tetramethyl-4-piperidyl)imino)-hexamethylene((2,2,6,6-tetramethyl-4-piperidyl)imino)] (CAS 90751-07-8); poly[[6-(4-morpholinyl)-1,3,5-triazine-2,4-diyl][(1,2,2,6,6-pentamethyl-4-piperidinyl)imino]-1,6-hexanediyl[(1,2,2,6,6-pentamethyl-4-piperidinyl)imino]] (CAS 219920-30-6); 3-dodecyl-1-(2,2,6,6-tetra methyl-4-piperidyl)pyrrolidine-2,5-dione (CAS 79720-19-7); 3-dodecyl-1-(1,2,2,6,6-pentamethyl-4-piperidinyl)pyrrolidine-2,5-dione (CAS 106917-30-0); 2,2,6,6-tetramethyl-4-piperidinyl octadecanoate (CAS 24860-22-8); N,N′-bis(2,2,6,6-tetramethyl-4-piperidinyl)-1,3-benzenedicarboxamide (CAS 42774-15-2); 2,2,4,4-tetramethyl-7-oxa-3,20-diazadispiro[5.1.11.2]heneicosan-21-one (CAS 6433846-5); tetrakis(1,2,2,6,6-pentamethyl-4-piperidinyl) butane-1,2,3,4-tetracarboxylate (CAS 91788-83-9); tetra kis(2,2,6,6-tetramethyl-4-piperidinyl) butane-1,2,3,4-tetracarboxylate (CAS 64022-61-3); 1,2,3,4-butanetetracarboxylic acid, 1,2,2,6,6-pentamethyl-4-piperidinyl tridecyl ester (CAS 107119-91-5); 1,2,3,4-butanetetracarboxylic acid, 2,2,6,6-tetramethyl-4-piperidinyl tridecyl ester (CAS 100631-43-4); alpha-alkenes (C20-C24) maleic anhydride-4-amino-2,2,6,6-tetramethylpiperidine, polymer (CAS 199237-39-3); 1,3-propanediamine, N1,N1′-1,2-ethanediylbis-, polymer with 2,4,6-trichloro-1,3,5-triazine, reaction products with N-butyl-2, 2,6,6-tetra methyl-4-piperidinamine (CAS 136504-96-6); N, N′-bis(2,2,6,6-tetramethyl-4-piperidinyl)-1,6-hexanediamine polymers with morpholine-2,4,6-trichloro-1,3,5-triazine reaction products, methylated (CAS 193098-40-7); N,N′-bis(2,2,6,6-tetramethyl-4-piperidyl)-N,N′-diformylhexamethylenediamine (CAS 124172-53-8); 2,2,6,6-tetramethyl-4-piperidinyl stearate (CAS 167078-06-0); and/or mixtures thereof.

Further specific, non-limiting examples of nitrogen-containing compounds according to the invention include 1,4-diazabicyclo[2.2.2]octane (CAS 280-57-9); diisopropyl ethylamine (CAS 7087-68-5); triacetonamine (CAS 826-36-8); n-methyl-morpholine (CAS 109-02-4); 3,3,5,5-tetramethylmorpholine (CAS 19412-12-5); 4-tert-butylmorpholine (CAS 33719-90-3); hexamethylenetetramine (CAS 100-97-0); 4-(1-methyl-1-phenylethyl)N-[4-(1-methyl-1-phenylethyl)phenyl] aniline (NAUGARD™ 445—CAS 10081-67-1); and/or mixtures thereof.

Compounds designated by the tradename LOWILITE™ and NAUGARD™ are available from SI Group USA (USAA), LLC, 4 Mountainview Terrace, Suite 200, Danbury, Conn. 06810.

The nitrogen-containing compound is present in the hydrolytically stabilised phosphite composition in an amount effective to stabilise the phosphite antioxidant against hydrolysis i.e. in an amount effective to act as a hydrostabiliser. For example, the nitrogen-containing compound may be present for the purpose of providing hydrostability in the hydrolytically stabilised phosphite composition in an amount of from about 0.01 wt. % to about 10 wt. %, from about 0.1 wt. % to about 5 wt. %, or from about 0.3 wt. % to about 3 wt. % by weight of the overall composition. Additional quantities, of HALS for example, may be present for UV or other stabilisation purposes in-polymer.

The phosphite antioxidant is a liquid at ambient conditions.

Preferably, the overall hydrolytically stabilised phosphite composition is a liquid at ambient conditions.

“Ambient conditions” in this context means atmospheric pressure (101.325 kPa) and a temperature of 25° C.

Many polymer manufacturers prefer liquid antioxidant compositions. Consequently, the apparatus used for feeding antioxidant compositions into the polymer is configured for liquids i.e. a liquid feed. Thus, from a convenience and cost perspective it is advantageous for the phosphite antioxidant and the overall hydrolytically stabilised phosphite composition to be a liquid at ambient conditions.

The phosphite antioxidant comprises a blend of at least two different phosphites of Formula I. Preferably, the phosphite antioxidant comprises a blend of at least three different phosphites of Formula I. More preferably, the phosphite antioxidant comprises a blend of at least four different phosphites of Formula I.

The C₁ to C₆ alkyl may be selected from methyl, ethyl, propyl, butyl, pentyl, hexyl and/or isomers thereof, for example isopropyl, isobutyl, sec-butyl, tert-butyl, isopentyl, tert-pentyl and/or neopentyl.

The phosphites in the blend may each independently have the structure of Formula III:

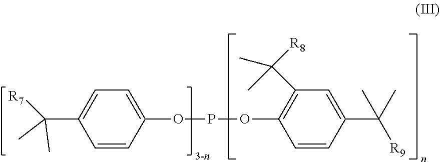

wherein R₇, R₈ and R₉ are independently selected from methyl and ethyl groups, and wherein n is 0, 1, 2 or 3.

The phosphites in the blend may be independently selected from tris(4-tert-butylphenyl) phosphite; tris(2,4-di-tert-butylphenyl) phosphite; bis(4-tert-butylphenyl)-2,4-di-tert-butylphenyl phosphite; bis(2,4-di-tert-butylphenyl)-4-tert-butylphenyl phosphite; tris(4-tert-pentylphenyl) phosphite; tris(2,4-di-tert-pentylphenyl) phosphite; bis(4-tert-pentylphenyl)-2,4-di-tert-pentylphenyl phosphite; and/or bis(2,4-di-tert-pentylphenyl)-4-tert-pentylphenyl phosphite.

The phosphites in the blend may be independently selected from, for example, tris(4-tert-pentylphenyl) phosphite; tris(2,4-di-tert-pentylphenyl) phosphite; bis(4-tert-pentylphenyl)-2,4-di-tert-pentylphenyl phosphite; and/or bis(2,4-di-tert-pentylphenyl)-4-tert-pentylphenyl phosphite.

A preferred phosphite antioxidant according to the invention is WESTON™ 705—CAS 939402-02-5.

Compounds designated by the tradename WESTON™ are available from SI Group USA (USAA), LLC, 4 Mountainview Terrace, Suite 200, Danbury, Conn. 06810.

The hydrolytically stabilised phosphite composition may be combined with other stabilisers, for example one or more phenolic antioxidants, aminic antioxidants, sulphur-containing antioxidants, and/or an acid scavengers.

The hydrolytically stabilised phosphite composition may be used to stabilise various types of polymers. The polymer may be stabilised against oxidative, thermal and/or radiation (for example light e.g. UV light) induced degradation.

According to another aspect of the present invention there is provided a stabilised polymer composition, comprising:
a polymer; and
the hydrolytically stabilised phosphite composition as hereinbefore described.

The polymer may be selected from one or more of a polyolefin, a rubber, a polyester, a polyurethane, a polyalkylene terephthalate, a polysulfone, a polyimide, a polyphenylene ether, a styrenic polymer, a polycarbonate, an acrylic polymer, a polyamide, and/or a polyacetal.

The hydrolytically stabilised phosphite composition may be present in an amount of from about 0.01% to about 10%, from about 0.01% to about 5%, from about 0.01% to about 3.5% or from about 0.01% to about 2% by weight of the stabilised polymer composition.

Hindered amine light stabilisers (HALS) are known additives for polymers. However, they are typically added in an amount of greater than 0.1% by weight of the polymer composition, for example in an amount of from about 0.2% to about 0.4% by weight of the polymer composition. Conversely, the nitrogen-containing compound of the present invention is present in the polymer composition in a very small amount, for example from about 0.0001% to about 0.05% by weight of the polymer composition. At the amounts contemplated by the present invention, a HALS-type nitrogen-containing compound does not behave as a light stabiliser, rather it behaves as a hydrolytic stabiliser for the phosphite antioxidant.

According to another aspect of the present invention there is provided a useful article made from the stabilised polymer composition as hereinbefore described.

The invention will now be more particularly described with reference to the following, non-limiting examples.

### EXAMPLES

The components used in the following examples are outlined in Table 1 below. Hereinafter, the components will be referred to using the name given in the ‘component’ column.

TABLE 1

| Component | Manufacturer | CAS No. | Chemical Description |
|---|---|---|---|
| TIPA | Sigma-Aldrich | 122-20-3 | Triisopropanolamine |
| NMM | Sigma-Aldrich | 109-02-4 | N-methylmorpholine |
| DABCO | Sigma-Aldrich | 280-57-9 | 1,4-diazabicyclo[2.2.2]octane |
| DEHA | Sigma-Aldrich | 3710-84-7 | Diethylhydroxylamine |
| DIPEA | Sigma-Aldrich | 7087-68-5 | Diisopropyl ethylamine |
| DBU | Sigma-Aldrich | 6674-22-2 | 1,8-diazabicyclo[5.4.0]undec-7-ene |
| LL76 | SI Group | 41556-26-7 | LOWILITE ™ 76 - bis(1,2,2,6,6- |
| | | | pentamethyl-4-piperidyl) sebacate |
| LL77 | SI Group | 52829-07-9 | LOWILITE ™ 77 - bis(2,2,6,6- |
| | | | tetramethyl-4-piperidyl) sebacate |
| LL92 | SI Group | 41556-26-7 | LOWILITE ™ 92 - Bis(1,2,2,6,6- |
| | | and | pentamethyl-4-piperidyl) sebacate |
| | | 82919-37-7 | and methyl(1,2,2,6,6-pentamethyl- |
| | | | 4-piperidinyl) sebacate |
| LL19 | SI Group | 106990-43-6 | LOWILITE ™ 19 - 1,3,5-triazine- |
| | | | 2,4,6-triamine, N2,N2′-1,2- |
| | | | ethanediylbis[N2-[3-[[4,6- |
| | | | bis[butyl(1,2,2,6,6-pentamethyl- |
| | | | 4-piperidinyl)amino]-1,3,5- |
| | | | triazin-2-yl]amino]propyl]- |
| | | | N4,N6-dibutyl-N4,N6-bis(1,2,2,6,6- |
| | | | pentamethyl-4-piperidinyl)- |
| TAA | Sigma-Aldrich | 826-36-8 | Triacetonamine |
| TMM | Sigma-Aldrich | 19412-12-5 | 3,3,5,5-tetramethylmorpholine |
| 26DTBP | Sigma-Aldrich | 585-48-8 | 2,6-di-tert-butylpyridine |
| W705 | SI Group | 939402-02-5 | WESTON ™ 705 - Mixed triaryl |
| | | | phosphites |
| PP18 | SI Group | 2082-79-3 | ANOX ™ PP18 - octadecyl-3-(3′,5′- |
| | | | di-tert-butyl-4′-hydroxyphenyl) |
| | | | propionate |
| ZnO | Sigma-Aldrich | 1314-13-2 | Zinc oxide |

### Investigation into PTAP Generation

Samples of WESTON™ 705 (phosphite antioxidant) and hydrostabiliser were prepared. The samples were kept in a nitrogen atmosphere at ambient temperature. The amount of PTAP was measured after 48 days using NMR. The results are shown in Table 2.

TABLE 2

| Example | Hydrostabiliser | Mole %* | Amount PTAP** |
|---|---|---|---|
| 1 (Comp) | TIPA | 0.6 | 0.094 |
| 2 (Comp) | TIPA | 0.9 | 0.099 |
| 3 (Comp) | TIPA | 1.2 | 0.116 |
| 4 (Comp) | DEHA | 0.6 | 0.085 |
| 5 (Comp) | DEHA | 0.9 | 0.1106 |
| 6 (Comp) | DEHA | 1.2 | 0.170 |
| 7 | NMM | 0.6 | 0.020 |
| 8 | NMM | 0.9 | 0.023 |
| 9 | NMM | 1.2 | 0.025 |
| 10 | DABCO | 0.6 | 0.027 |

*mole % in overall composition
**Integral of the signal from the 2,6 hydrogens of PTAP in the ¹H NMR spectrum (doublet at 6.73 ppm) relative to the integral of signals from aromatic hydrogens resonating between 6.76 ppm and 7.7 ppm, with the sum of these 2 integrals set to 100 units and the chemical shift axis being calibrated to the internal standard TMS at 0.0 ppm, with the sample analysed at 298 K as 100 μL dissolved in 700 μL deuterochloroform and the resonance frequency of ¹H being 400 MHz

The amount of PTAP in WESTON™ 705 phosphite antioxidant (without hydrostabiliser) was measured as 0.021. From the results it can be seen that addition of NMM and DABCO hydrostabilisers (both nitrogen-containing compounds according to the present invention) cause very little change in the amount of PTAP. The amount of PTAP generated when TIPA or DEHA is used as the hydrostabiliser is significantly greater.

It is believed that the free —OH group in TIPA and DEHA reacts with the phosphite antioxidant in a transesterification reaction which produces unwanted products such as PTAP. Conversely, the nitrogen-containing compounds according to the present invention, such as NMM and DABCO, are absent any labile protons and thus, do not react with the phosphite antioxidant in this way.

### Investigation into Hydrolytic Stability of Phosphite Antioxidant at 35° C., 50% RH

200 μL samples of WESTON™ 705 (phosphite antioxidant) and hydrostabiliser in uncapped 1.8 mL HPLC vials were prepared. In addition, 200 μL samples of WESTON™ 705 with no hydrostabiliser in uncapped 1.8 mL HPLC vials were prepared . The samples were maintained at 35° C. and 50% relative humidity in a MEMMERT™ humidity chamber. The % amount of active phosphite was monitored using a comparison of ³¹P NMR integrals. 700 μL of CDCl₃ was added to the 200 μL samples prior to ³¹P NMR analysis. The survival time of the phosphite was the time at which 50% active phosphite remained in the sample.

The results are shown in Table 3.

TABLE 3

| | Hydro- | | Survival Time | Relative Survival |
|---|---|---|---|---|
| Example | stabiliser | Mole %* | (days) | Time** |
| 11 (Comp) | TIPA | 0.6 | 9.0 | 1 |
| 12 (Comp) | TIPA | 0.9 | 13.5 | 1.5 |
| 13 (Comp) | TIPA | 1.2 | 18.0 | 2 |
| 14 | NMM | 0.6 | 5.0 | 0.56 |
| 15 | NMM | 0.9 | 5.5 | 0.61 |
| 16 | NMM | 1.2 | 6.0 | 0.67 |
| 17 | DABCO | 0.6 | 6.0 | 0.67 |
| 18 (Comp) | None | — | 1.0 | 0.11 |

*mole % in overall composition
**Survival time relative to TIPA at 0.6 mole %

From the results it can be seen that the nitrogen-containing compounds according to the present invention significantly improve the survival time of the phosphite antioxidant compared to the example in which no hydrostabiliser is present. The survival times show that the nitrogen-containing compounds according to the present invention provide good hydrolytic stability to the phosphite antioxidant.

### Investigation into Hydrolytic Stability of Phosphite Antioxidant at 50° C., 50% RH

200 μL samples of WESTON™ 705 (phosphite antioxidant) and hydrostabiliser in uncapped 1.8 mL HPLC vials were prepared. In addition, 200 μL samples of WESTON™ 705 with no hydrostabiliser in uncapped 1.8 mL HPLC vials were prepared The samples were maintained at 50° C. and 50% relative humidity in a MEMMERT™ humidity chamber. The % amount of active phosphite was monitored using a comparison of ³¹P NMR integrals. 700 μL of CDCl₃ was added to the 200 μL samples prior to ³¹P NMR analysis. The survival time of the phosphite was the time at which 50% active phosphite remained in the sample. The results are shown in Table 4.

TABLE 4

| | | | | Survival | Relative |
|---|---|---|---|---|---|
| | Hydro- | | | Time | Survival |
| Example | stabiliser | pKaH | Mole %* | (days) | Time** |
| 19 (Comp) | 26DTBP | 3.6 | 0.6 | 1 | 0.17 |
| 20 | TMM | 8 | 0.6 | 3 | 0.5 |
| 21 (Comp) | TIPA | 8.08 | 0.6 | 6 | 1 |
| 22 | DIPEA | 10.8 | 0.6 | 3.25 | 0.54 |
| 23 | TAA | 8.5 | 0.6 | 5.7 | 0.95 |
| 24 | LL92 | 10 | 0.35 | 6 | 1 |
| 25 (Comp) | DBU | 13.5 | 0.6 | 1 | 0.17 |
| 26 (Comp) | None | — | — | 0.2 | 0.03 |

*mole % in overall composition
**Survival time relative to TIPA at 0.6 mole %

From the results it can be seen that the nitrogen-containing compounds according to the present invention significantly improve the survival time of the phosphite antioxidant compared to the example in which no hydrostabiliser is present. The survival times show that the nitrogen-containing compounds according to the present invention provide good hydrolytic stability to the phosphite antioxidant even under harsh conditions.

The results also highlight the importance of the pKaH value of the nitrogen atom in the compound. Those compounds containing a nitrogen atom having a pKaH value in the range of from about 7 to about 11 all provide better hydrolytic stability to the phosphite antioxidant compared to those compounds containing a nitrogen atom having a pKaH value outside of the stated range.

Comparative example 19 involves a nitrogen-containing compound wherein the nitrogen atom has a pKaH value of 3.6. This example highlights that a compound having a low pKaH value falling outside of the stated range does not provide good hydrolytic stability to a phosphite antioxidant. It is believed that nitrogen-containing compounds with low pKaH values are ineffective at neutralising acids.

Comparative example 25 involves a nitrogen-containing compound wherein the nitrogen atom has a pKaH value of 13.5. This example highlights that a compound having a high pKaH value falling outside of the stated range does not provide good hydrolytic stability to a phosphite antioxidant. Without wishing to be bound by any such theory, it is believed that the high basicity promotes base-catalysed hydrolysis of the phosphite antioxidant.

### Investigation into HALS-Type Compounds as Hydrostabilisers

### Hydrolytic Stability of Phosphite Antioxidant at 50° C., 50% RH

200 μL samples of WESTON™ 705 (phosphite antioxidant) and hydrostabiliser in uncapped 1.8 mL HPLC vials were prepared. The samples were maintained at 50° C. and 50% relative humidity in a MEMMERT™ humidity chamber. The % amount of active phosphite was monitored using a comparison of ³¹P NMR integrals. 700 μL of CDCl₃ was added to the 200 μL samples prior to ³¹P NMR analysis. The survival time of the phosphite was the time at which 50% active phosphite remained in the sample. The results are shown in Table 5.

TABLE 5

| | Hydro- | | Survival Time | Relative Survival |
|---|---|---|---|---|
| Example | stabiliser | Mole %* | (days) | Time** |
| 27 (Comp) | TIPA | 0.6 | 7.0 | 1 |
| 28 | LL92 | 0.35 | 6.5 | 0.93 |
| 29 | LL92 | 0.53 | 7.0 | 1 |
| 30 | LL92 | 0.71 | 7.0 | 1 |
| 31 | LL77 | 0.3 | 5.0 | 0.71 |
| 32 | LL77 | 0.6 | 11.0 | 1.57 |
| 33 | LL76 | 0.3 | 4.0 | 0.57 |
| 34 | LL76 | 0.45 | 7.0 | 1 |
| 35 | LL76 | 0.6 | 11.0 | 1.57 |

*mole % in overall composition
**Survival time relative to TIPA at 0.6 mole %

From the results it can be seen that the HALS-type nitrogen-containing compounds according to the present invention perform comparably and, in some instances, perform better than TIPA as a hydrostabiliser for the phosphite antioxidant.

### LL92—Hydrolytic Stability of Phosphite Antioxidant at 30° C., 70% RH

200 μL samples of WESTON™ 705 (phosphite antioxidant) and hydrostabiliser in uncapped 1.8 mL HPLC vials were prepared in the amounts shown in Table 6.

TABLE 6

| Example | Hydrostabiliser | Mole %* |
|---|---|---|
| 36 (Comp) | None | — |
| 37 (Comp) | TIPA | 0.2 |
| 38 (Comp) | TIPA | 0.6 |
| 39 | LL92 | 0.5 |
| 40 | LL92 | 1 |

*mole % in overall composition

The samples were maintained at 30° C. and 70% relative humidity in a MEMMERT™ humidity chamber. The % amount of active phosphite was monitored at various intervals using a comparison of ³¹P NMR integrals. 700 μL of CDCl₃ was added to the 200 μL samples prior to ³¹P NMR analysis. The results are shown in Table 7.

TABLE 7

| | % Active Phosphite | | | | |
|---|---|---|---|---|---|
| No. Days | 36 (Comp) | 37 (Comp) | 38 (Comp) | 39 | 40 |
| 0 | 99.49 | 99.84 | 99.34 | 99.75 | 99.79 |
| 1 | 56.27 | 99.84 | 99.34 | 99.75 | 99.79 |
| 2 | 5.01 | 99.81 | 99.50 | 99.82 | 99.84 |
| 6 | 0.00 | 99.71 | 99.41 | 99.73 | 99.68 |
| 13 | 0.00 | 99.73 | 99.42 | 99.75 | 99.70 |
| 16 | 0.00 | 99.77 | 99.46 | 99.78 | 99.73 |
| 20 | 0.00 | 99.64 | 99.30 | 99.48 | 99.66 |
| 26 | 0.00 | 99.72 | 99.33 | 99.75 | 99.66 |

From the results it can be seen that LL92 (a nitrogen-containing compound according to the invention) performs comparably to TIPA as a hydrostabiliser for the phosphite antioxidant.

The amount of PTAP generated was also monitored at various time intervals for examples 38 to 40 and the results are shown in Table 8.

TABLE 8

| | Amount PTAP (%) | | |
|---|---|---|---|
| No. Days | 38 (Comp) | 39 | 40 |
| 0 | 0.51 | 0.00 | 0.04 |
| 2 | 0.38 | 0.00 | 0.00 |
| 6 | 0.48 | 0.04 | 0.06 |
| 13 | 0.49 | 0.07 | 0.11 |
| 16 | 0.43 | 0.06 | 0.12 |
| 26 | 0.51 | 0.13 | 0.18 |

From the results it can be seen that the phosphite antioxidant stabilised with LL92 (a nitrogen-containing compound according to the present invention) results in less PTAP being generated compared to the phosphite antioxidant stabilised with TIPA.

### LL92—Preparation of Polyethylene Compositions

Polyethylene compositions were prepared by blending a polyethylene homopolymer with an antioxidant package at loadings shown in Table 9. The polyethylene compositions were melt compounded in a single screw extruder at 190° C. under nitrogen.

TABLE 9

Amount (ppm)

| Component | 41 (Comp) | 42 | 43 | 44 (Comp) |
|---|---|---|---|---|
| PP18 | 1000 | 1000 | 1000 | 1000 |
| W705 | 1500 | — | — | — |
| W705 + 0.5% TIPA | — | — | — | 1500 |
| W705 + 0.5% LL92 | — | 1500 | — | — |
| W705 + 1% LL92 | — | — | 1500 | — |
| ZnO | 500 | 500 | 500 | 500 |

### LL92—Hydrolytic Stability of Phosphite Antioxidant (In-Polymer) at 50° C., 80% RH

Samples of the polyethylene compositions were maintained at 50° C. and 80% relative humidity in a MEMMERT™ humidity chamber. The % amount of active phosphite was monitored at various intervals using a comparison of ³¹P NMR integrals. The results are shown in Table 10.

TABLE 10

| | % Active Phosphite | | |
|---|---|---|---|
| No. Weeks | 41 (Comp) | 42 | 43 |
| 0 | 100.00 | 100.00 | 100.00 |
| 2 | 91.32 | 95.22 | 96.34 |
| 4 | 83.05 | 95.59 | 94.94 |
| 8 | 48.50 | 94.07 | 94.88 |

From the results it can be seen that the nitrogen-containing compound according to the invention, LL92, significantly improves the in-polymer survival time of the phosphite antioxidant compared to the example in which no hydrostabiliser is present. The survival times show that LL92 provides good in-polymer hydrolytic stability to the phosphite antioxidant even under harsh conditions.

### LL92—Polymer Melt Flow Index

Samples of each of the polyethylene compositions identified as examples 42 to 44 were multi-passed through an extruder at 260° C. under air. Extrusion experiments were performed on a 25 mm SS BRABENDER™ extruder.

The melt flow index (MFI) was determined following compounding (pass 0) and after passes 1, 3 and 5 using a CEAST™ 7026 melt flow tester according to standard test method ASTM D1238 with a temperature of 190° C., a 2.16 kg weight and a 2.095 mm die. An increase in the melt flow index is indicative of unfavourable degradation of the polymer. It is desirable for the properties of the polyethylene composition to be maintained on processing. The results are shown in Table 11.

TABLE 11

MFI (g/10 min)

| Example | Pass 0 | Pass 1 | Pass 3 | Pass 5 |
|---|---|---|---|---|
| 42 | 3.715 | 3.721 | 3.715 | 3.684 |
| 43 | 3.725 | 3.735 | 3.732 | 3.685 |
| 44 (Comp) | 3.694 | 3.716 | 3.705 | 3.668 |

From the results it can be seen that the polyethylene compositions involving the hydrolytically stabilised phosphite composition according to the present invention (examples 42 and 43) retained melt flow index similarly to the polyethylene composition involving TIPA as the hydrostabiliser for the phosphite antioxidant (Example 44).

### LL92—Polymer Colour Stability

Samples of each of the polyethylene compositions identified as examples 42 to 44 were multi-passed through an extruder at 260° C. under air. Extrusion experiments were performed on a 25 mm SS BRABENDER™ extruder.

The colour stability was tested following compounding (pass 0) and after passes 1, 3 and 5. After each pass through the extruder, the polyethylene composition was cooled in a water bath, dried and chipped to give pellets which were analysed and subjected to the same procedure again. The discolouration of the polyethylene compositions was measured in terms of Yellowness Index (YI) using a colorimeter (XRITE™ Color i7) according to standard test method ASTM D1925. The lower the YI values, the less discolouration of the polyethylene composition. The results are shown in Table 12.

TABLE 12

YI Value

| Example | Pass 0 | Pass 1 | Pass 3 | Pass 5 |
|---|---|---|---|---|
| 42 | −3.895 | −2.857 | −0.932 | 0.768 |
| 43 | −3.901 | −2.670 | −0.626 | 1.043 |
| 44 (comp) | −3.471 | −1.546 | 0.041 | 1.426 |

With regards to colour stability, it can be seen that the polyethylene compositions involving the hydrolytically stabilised phosphite composition according to the present invention (examples 42 and 43) performed at least as well as the polyethylene composition involving TIPA as the hydrostabiliser for the phosphite antioxidant (Example 44).

### LL92—Polymer Gas Fading

The gas fading of the polyethylene compositions of examples 42 to 44 was measured in accordance with standard test method AATCC 23 at a temperature of 60° C. The discolouration of the polyethylene compositions was measured in terms of Yellowness Index (YI) using a colorimeter (XRITE™ Color i7) according to standard test method ASTM D1925. The results are shown in Table 13.

TABLE 13

| | YI Value | | |
|---|---|---|---|
| Days | 42 | 43 | 44 (Comp) |
| 0 | −2.649 | −2.482 | −1.338 |
| 4 | 0.934 | 1.030 | 2.099 |
| 7 | 3.285 | 3.637 | 4.454 |
| 11 | 4.953 | 5.255 | 5.922 |
| 14 | 7.124 | 7.574 | 7.827 |
| 18 | 8.842 | 9.449 | 9.479 |
| 21 | 9.924 | 10.482 | 10.367 |
| 25 | 11.286 | 11.870 | 11.700 |
| 28 | 12.071 | 12.740 | 12.537 |

From the results it can be seen that the polyethylene compositions involving the hydrolytically stabilised phosphite composition according to the present invention (examples 42 and 43) exhibited good gas fading performance which is comparable to the polyethylene composition involving TIPA as the hydrostabiliser for the phosphite antioxidant (Example 44).

### LL92—Water-Based Polymerisation Applications

Phosphite antioxidants are often used in water-based polymerisation applications. In such applications, hydrolysis of the phosphite antioxidant can occur due to exposure to water. An investigation was carried out into the hydrostabilisation provided by LL92 when directly exposed to water.

50 mL samples of WESTON™ 705 (phosphite antioxidant) and hydrostabiliser were prepared. The hydrostabilisers tested are shown in Table 14.

TABLE 14

| Example | Hydrostabiliser | Mole % |
|---|---|---|
| 45 (Comp) | None | — |
| 46 (Comp) | TIPA | 0.6 |
| 47 | LL92 | 0.353 |

A bromophenol blue indicator solution was prepared by adding 100 mL of tap water to 4 mL bromophenol blue 0.04% in 85%/15% water/ethanol.

20 mL of the phosphite antioxidant/hydrostabiliser mixture and 60 mL of bromophenol blue indicator solution were added to a flask. Stoppers were used to close the side arms of the flask. A watch glass was used to lid the flask loosely. The flask was placed in a RADLEY™ 600 W hot block. The sample was stirred at ˜600 RPM using magnetic stirrer bars. The sample was maintained at 60° C. and filmed using a camera looking down onto the sample.

The time taken for complete hydrolysis of the sample was measured by observing a colour change in the indicator solution. More specifically, the time at which the colour changed from blue to yellow was taken to be the point of complete hydrolysis—this colour change indicates that dihydrogenphosphite (‘H2’) and phosphorus acid (H₃PO₃), hydrolysis products of phosphites, are present in the solution (note: bromophenol blue is yellow at pH 3.0 and below and is blue at pH 4.6 and above). The test was repeated a second time for each sample. The results are shown in Table 15.

TABLE 15

| | Time (Hours) | | |
|---|---|---|---|
| Example | Experiment 1 | Experiment 2 | Average |
| 45 (Comp) | 1.83 | 1.5 | 1.67 |
| 46 (Comp) | 42 | 54.5 | 48.25 |
| 47 | 250 | 139.5 | 194.75 |

From the results it can be seen that the hydrostabiliser according to the invention (Example 47) greatly improves the hydrostability of the phosphite antioxidant when directly exposed to water compared to the sample in which no hydrostabiliser is present (Example 45) and compared to the sample involving TIPA as the hydrostabiliser (Example 46).

### Investigation into Thermal Stability of HALS-Type Hydrostabilisers

Samples of 50 g WESTON™ 705 (phosphite antioxidant) and hydrostabiliser were prepared to achieve the mole % loadings shown in Table 17. A 50 g WESTON™ 705 sample with no hydrostabiliser was also prepared.

TABLE 16

| Example | Hydrostabiliser | Mole %* |
|---|---|---|
| 48 (Comp) | None | — |
| 49 | LL92 | 0.9 |
| 50 | LL92 | 1.8 |
| 51 | LL77 | 0.75 |
| 52 | LL77 | 1.5 |
| 53 (Comp) | TIPA | 1.5 |

*mole % in overall composition

The samples were thoroughly mixed at 60° C. to achieve full dissolution. Samples were padded with N₂ in Schott bottles, tightly capped and placed in an oven at 80° C. The samples remained under these conditions for 1 week.

The amount of PTAP was measured at 0 weeks and after 1 week at 80° C. using ¹H NMR. The sample was thoroughly mixed and then 150 μL of the sample was dissolved in 700 μL CDCl₃. ¹H NMR spectra were taken at 298 K under automation using a Bruker AVANCE™ III 400 MHz NMR spectrometer. The results are shown in Table 17.

TABLE 17

| | Amount PTAP* | | | | | |
|---|---|---|---|---|---|---|
| Time | 48 | | | | | 53 |
| (Weeks) | (Comp) | 49 | 50 | 51 | 52 | (Comp) |
| 0 | 0.1246 | 0.0107 | 0.0162 | 0.0000 | 0.0000 | 0.0704 |
| 1 | 0.6860 | 0.0315 | 0.0405 | 0.0260 | 0.0168 | 0.3871 |

*Integral of the signal from the 2,6 hydrogens of PTAP in the ¹H NMR spectrum (doublet at 6.73 ppm) relative to the integral of signals from aromatic hydrogens resonating between 6.76 ppm and 7.7 ppm, with the sum of these 2 integrals set to 100 units and the chemical shift axis being calibrated to the internal standard TMS at 0.0 ppm, with the sample analysed at 298 K as 100 μL dissolved in 700 μL deuterochloroform and the resonance frequency of ¹H being 400 MHz

Generation of PTAP can be used to indicate the thermal stability of the sample—the more PTAP generated, the less thermally stable the sample.

From the results, the low levels of PTAP generated for examples 49 to 52 show that the phosphite antioxidant samples stabilised with LL92 and LL77 according to the present invention are thermally stable at 80° C. for 1 week. Conversely, the higher levels of PTAP generated for Example 53 show that the phosphite antioxidant stabilised with TIPA is less thermally stable under the same conditions.

The levels of PTAP for examples 51 and 52 (LL77) are remarkably low.

The increase in PTAP for Example 48 (no hydrostabiliser) is attributed to hydrolysis due to the presence of some water in the phosphite antioxidant initially. The slight increase in PTAP for examples 49 and 50 (LL92) is, again, attributed to hydrolysis due to the presence of some water in the phosphite antioxidant initially, as opposed to transesterification.

The significant increase in PTAP for Example 53 (TIPA) is attributed to transesterification of the phosphite antioxidant and hydrolysis due to the presence of some water in the phosphite antioxidant initially.

### LL19—Hydrolytic Stability of Phosphite Antioxidant at 50° C., 50% RH

200 μL samples of WESTON™ 705 (phosphite antioxidant) and hydrostabiliser were prepared in the amounts shown in Table 18.

TABLE 18

| Example | Hydrostabiliser | Mole %* |
|---|---|---|
| 54 (Comp) | None | — |
| 55 (Comp) | TIPA | 0.6 |
| 56 | LL19 | 0.075** |

*mole % in overall composition
**0.075 mole % LL19 has an active equivalent N-content to 0.6 mole % TIPA (by active N is meant one that has pKaH from 7 to 11, is sp³ hybridised and has no labile N—H groups)

The samples were maintained at 50° C. and 50% relative humidity in a MEMMERT™ humidity chamber. The % amount of active phosphite was monitored at various intervals using a comparison of ³¹P NMR integrals. The results are shown in Table 19.

TABLE 19

| | % Active Phosphite | | |
|---|---|---|---|
| No. Days | 54 (Comp) | 55 (Comp) | 56 |
| 0 | 100.00 | 100.00 | 100.00 |
| 1 | 0 | 100.00 | 100.00 |
| 11 | 0 | 100.00 | 100.00 |

From the results it can be seen that LL19 (a nitrogen-containing compound according to the invention) performs comparably to TIPA as a hydrostabiliser for the phosphite antioxidant.

It was visually observed that the sample with LL19 (Example 56) remained clear throughout the experiment whereas the sample with TIPA (Example 55) became turbid after 1 day.

1. A hydrolytically stabilised phosphite composition, comprising:
a. a phosphite antioxidant which is a liquid at ambient conditions and comprises a blend of at least two different phosphites of Formula I: 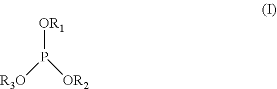
wherein R₁, R₂ and R₃ are independently selected alkylated aryl groups of Formula II: 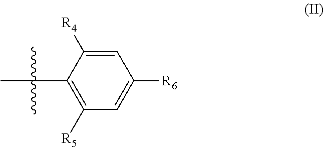
wherein R₄, R₅ and R₆ are independently selected from the group consisting of hydrogen and C₁ to C₆ alkyl, provided that at least one of R₄, R₅ and R₆ in each phosphite is selected from the group consisting of tert-butyl and/or tert-pentyl; and
b. a nitrogen-containing compound comprising a nitrogen atom, wherein the nitrogen atom:
i. has a pKaH value of from about 7 to about 11; and
ii. is spa hybridised,
and wherein the nitrogen-containing compound is absent any labile protons.

2. The hydrolytically stabilised phosphite composition according to claim 1, wherein the hydrolytic stability of the phosphite antioxidant relative to the hydrolytic stability of the same phosphite antioxidant stabilised with an equivalent amount of triisopropanolamine (TIPA) is at least about 0.4 relative to an equivalently TIPA-stabilised phosphite antioxidant.

3. The hydrolytically stabilised phosphite composition according to claim 1, wherein the hydrolytic stability of the phosphite antioxidant relative to the hydrolytic stability of the same phosphite antioxidant stabilised with an equivalent amount of triisopropanolamine (TIPA) is at least about 0.5 relative to an equivalently TIPA-stabilised phosphite antioxidant.

4. The hydrolytically stabilised phosphite composition according to claim 1, wherein the amount of PTAP in the composition with 0.6 mole % of the nitrogen-containing compound after 48 days under nitrogen at ambient temperature is no more than about 3 times higher than the initial amount of PTAP, measured as the integral of the signal from the 2,6 hydrogens of PTAP in the ¹H NMR spectrum (doublet at 6.73 ppm) relative to the integral of signals from aromatic hydrogens resonating between 6.76 ppm and 7.7 ppm, with the sum of these 2 integrals set to 100 units and the chemical shift axis being calibrated to the internal standard TMS at 0.0 ppm, with the sample analysed at 298 K as 100 μL dissolved in 700 μL deuterochloroform and the resonance frequency of ¹H being 400 MHz.

5. The hydrolytically stabilised phosphite composition according to claim 1, wherein the nitrogen-containing compound comprises one or more electron-withdrawing groups.

6. The hydrolytically stabilised phosphite composition according to claim 5, wherein the one or more electron-withdrawing groups are located 2, 3 or 4 covalent bonds away from the nitrogen atom.

7. The hydrolytically stabilised phosphite composition according to claim 5, wherein the one or more electron-withdrawing groups are selected from halogens; oxygen-containing groups; and/or nitrogen-containing groups.

8. The hydrolytically stabilised phosphite composition according to claim 5, wherein the one or more electron-withdrawing groups are selected from ketone, ester and/or ether groups.

9. The hydrolytically stabilised phosphite composition according to claim 1, wherein the nitrogen atom of the nitrogen-containing compound has a pKaH value of from about 9 to about 11.

10. The hydrolytically stabilised phosphite composition according to claim 1, wherein the nitrogen-containing compound comprises one or more 2,2,6,6-tetramethyl-piperidine derivatives.

11. The hydrolytically stabilised phosphite composition according to claim 10, wherein the 2,2,6,6-tetramethyl-piperidine derivative comprises one or more groups having the following structure: 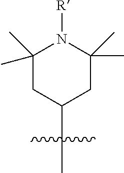
wherein R′ is hydrogen, CH₃, or CH₂R′ with R″ comprising —CH₂O(CO)CH₂CH₂CO₂— as a polymeric linker.

12. The hydrolytically stabilised phosphite composition according to claim 1, wherein the nitrogen-containing compound is selected from one or more of bis(1,2,2,6,6-pentamethyl-4-piperidyl) sebacate; bis(2,2,6,6-tetramethyl-4-piperidyl) sebacate; mixtures of bis(1,2,2,6,6-pentamethyl-4-piperidyl) sebacate and methyl(1,2,2,6,6-pentamethyl-4-piperidinyl) sebacate; poly[[6-[(1,1,3,3-tetramethylbutyl)amino]-1,3,5-triazine-2,4-diyl][(2,2,6,6-tetramethyl-4-piperidyl)imino]hexamethylene[(2,2,6,6-tetramethyl-4-piperidyl)imino]]; 1,3,5-triazine-2,4,6-triamine, N2,N2′-1,2-ethanediylbis[N2-[3-[[4,6-bis[butyl(1,2,2,6,6-pentamethyl-4-piperidinyl)amino]-1,3,5-triazin-2-yl]amino]propyl]-N4,N6-dibutyl-N4,N6-bis(1,2,2,6,6-pentamethyl-4-piperidinyl)-; butanedioic acid, dimethyl ester, polymer with 4-hydroxy-2,2,6,6-tetramethyl-1-piperidine-ethanol; 1,6-hexanediamine, N, N′-bis(2,2,6,6-tetramethyl-4-piperidinyl)-, polymer with 2,4,6-trichloro-1,3,5-triazine, reaction products with N-butyl-1-butanamine and N-butyl-2,2,6,6-tetramethyl-4-piperidinamine; poly[(6-morpholino-1,3,5-triazine-2,4-diyl)((2,2,6,6-tetramethyl-4-piperidyl)imino)-hexamethylene((2,2,6,6-tetramethyl-4-piperidyl)imino)]; poly[[6-(4-morpholinyl)-1,3,5-triazine-2,4-diyl][(1,2,2,6,6-pentamethyl-4-piperidinyl)imino]-1,6-hexanediyl[(1,2,2,6,6-pentamethyl-4-piperidinyl)imino]]; 3-dodecyl-1-(2,2,6,6-tetramethyl-4-piperidyl)pyrrolidine-2,5-dione; 3-dodecyl-1-(1,2,2,6,6-pentamethyl-4-piperidinyl)pyrrolidine-2,5-dione; 2,2,6,6-tetramethyl-4-piperidinyl octadecanoate; N,N′-bis(2,2,6,6-tetramethyl-4-piperidinyl)-1,3-benzenedicarboxamide; 2,2,4,4-tetramethyl-7-oxa-3,20-diazadispiro[5.1.11.2]heneicosan-21-one; tetrakis(1,2,2,6,6-pentamethyl-4-piperidinyl) butane-1,2,3,4-tetracarboxylate; tetrakis(2,2,6,6-tetramethyl-4-piperidinyl) butane-1,2,3,4-tetracarboxylate; 1,2,3,4-butanetetracarboxylic acid, 1,2,2,6,6-pentamethyl-4-piperidinyl tridecyl ester; 1,2,3,4-butanetetracarboxylic acid, 2,2,6,6-tetramethyl-4-piperidinyl tridecyl ester; alpha-alkenes (C20-C24) maleic anhydride-4-amino-2,2,6,6-tetramethylpiperidine, polymer; 1,3-propanediamine, N1,N1′-1,2-ethanediylbis-, polymer with 2,4,6-trichloro-1,3,5-triazine, reaction products with N-butyl-2,2,6,6-tetramethyl-4-piperidinamine; N,N′-bis(2,2,6,6-tetramethyl-4-piperidinyl)-1,6-hexanediamine polymers with morpholine-2,4,6-trichloro-1,3,5-triazine reaction products, methylated; N,N′-bis(2,2,6,6-tetramethyl-4-piperidyl)-N,N′-diformylhexamethylenediamine; 2,2,6,6-tetramethyl-4-piperidinyl stearate; 1,4-diazabicyclo[2.2.2]octane; diisopropyl ethylamine; triacetonamine; n-methyl-morpholine; 3,3,5,5-tetramethylmorpholine; 4-tert-butylmorpholine; hexamethylenetetramine; 4-(1-methyl-1-phenylethyl)N-[4-(1-methyl-1-phenylethyl)phenyl] aniline; and/or mixtures thereof.

13. The hydrolytically stabilised phosphite composition according to claim 1, wherein the nitrogen-containing compound is present in an amount of from about 0.01 wt. % to about 10 wt. % by weight of the hydrolytically stabilised phosphite composition.

14. The hydrolytically stabilised phosphite composition according to claim 1, wherein the phosphite antioxidant comprises a blend of at least four different phosphites of Formula I.

15. The hydrolytically stabilised phosphite composition according to claim 1, wherein the phosphites in the blend each independently have the structure of Formula III: 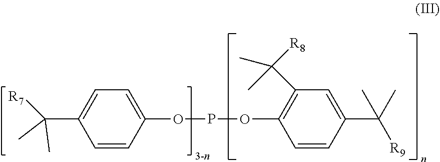
wherein R₇, R₈ and R₉ are independently selected from methyl and ethyl groups, and
wherein n is 0, 1, 2 or 3.

16. The hydrolytically stabilised phosphite composition according to claim 1, wherein the phosphites in the blend are independently selected from tris(4-tert-butylphenyl) phosphite; tris(2,4-di-tert-butylphenyl) phosphite; bis(4-tert-butylphenyl)-2,4-di-tert-butylphenyl phosphite; bis(2,4-di-tert-butylphenyl)-4-tert-butylphenyl phosphite; tris(4-tert-pentylphenyl) phosphite; tris(2,4-di-tert-pentylphenyl) phosphite; bis(4-tert-pentylphenyl)-2,4-di-tert-pentylphenyl phosphite; and/or bis(2,4-di-tert-pentylphenyl)-4-tert-pentylphenyl phosphite.

17. The hydrolytically stabilised phosphite composition according to claim 1, wherein the phosphites in the blend are independently selected from tris(4-tert-pentylphenyl) phosphite; tris(2,4-di-tert-pentylphenyl) phosphite; bis(4-tert-pentylphenyl)-2,4-di-tert-pentylphenyl phosphite; and/or bis(2,4-di-tert-pentylphenyl)-4-tert-pentylphenyl phosphite.

18. The hydrolytically stabilised phosphite composition according to claim 1, wherein the hydrolytically stabilised phosphite composition is a liquid at ambient conditions.

19. (canceled)

20. A stabilised polymer composition, comprising:
a polymer; and
the hydrolytically stabilised phosphite composition according to claim 1.

21. The stabilised polymer composition according to claim 20, wherein the hydrolytically stabilised phosphite composition is present in an amount of from about 0.01% to about 10% by weight of the stabilised polymer composition.

22. The stabilised polymer composition according to claim 20, wherein the nitrogen-containing compound is present in an amount of from about 0.0001% to about 0.05% by weight of the stabilised polymer composition.

23. A useful article made from the stabilised polymer composition according to claim 20.
